(19) United States
(12) Patent Application Publication
(10) Pub. No.: US 2013/0295545 A1
(43) Pub. Date: Nov. 7, 2013

(54) NON-LINEAR QUEST-BASED LEARNING APPARATUS AND METHOD

(71) Applicants: Lisa Dawley, Boise, ID (US); Charles Haskell, Boise, ID (US)

(72) Inventors: Lisa Dawley, Boise, ID (US); Charles Haskell, Boise, ID (US)

(73) Assignee: Boise State University

(21) Appl. No.: 13/461,017

(22) Filed: May 1, 2012

(51) Int. Cl. G09B 5/00

(52) U.S. Cl. 434/350

(57) ABSTRACT

A method of teaching in a cloud-based learning environment is disclosed herein. In this method, students are presented with a group of quest files wherein each quest file corresponds to a non-linear quest-based curriculum. The method includes creating a group of quests files to enable a student to pursue a non-linear quest path to reach at least one predetermined learning objective. The method also includes associating the group of quest files and the at least one predetermined learning objective with at least one standard and using achievement tracking tools configured to indicate a status associated with each student. The achievement tracking tools are configured to indicate (1) each quest activity that each student has commenced, (2) a progress associated with each quest activity, and (3) each quest activity that each student has successfully completed. The method also includes using evaluation tools to evaluate work of each student.

### BACKGROUND

The present application relates generally to the field of online learning environments and more specifically to non-linear quest-based learning environments.

Traditional curricula are classroom-based. Students are typically taught in large groups using lectures during which students are expected to memorize material to supplement materials provided prior or subsequent to the lectures. Traditional classroom-based teaching methods tend to “teach to the middle,” meaning that the most advanced students in the class tend to become bored because the pace of the class is too slow for them, while the least advanced students in the class tend to fall behind and become frustrated because the pace of the class is too fast for them.

Traditional learning environments are also typified by a lack of customization to personal learning needs and interests. For instance, in a given class, to achieve a passing grade it may be necessary to complete to the satisfaction of the instructor, a series of predetermined assignments and/or tests with little-to-no room to do so selectively. Therefore, classrooms often have a stifling feel where students are encouraged to participate well enough to pass, while not encouraged to explore a variety of learning paths that might meet their own interests, as well as achieve the required standards that the teacher has to teach.

Online learning environments attempt to provide an Internet-based resource to aid teachers in traditional classroom environments. However, traditionally, these online environments offer little more than an extension of the typically inflexible classroom environments and thereby continue to teach to middle and fail to offer personalized learning options.

### SUMMARY

A method of teaching in a cloud-based learning environment is disclosed herein. In this method, students are presented with a group of quest files wherein each quest file corresponds to a non-linear quest-based curriculum. The method includes creating a group of quests files to enable a student to pursue a non-linear quest path to reach at least one predetermined learning objective, wherein a quest file comprises a computer-accessible file having instructions for a quest activity that is presented to a student when the student has met all prerequisites associated with the quest file, and wherein at least one of (1) the group of quest files, and (2) the at least one predetermined learning objective, is created by a teacher of the student. Each quest file in the group of quest files is configured to be associated with at least one of a plurality of student-mediated factors, and further wherein the at least one student-mediated factor comprises any factor that permits a student to influence (1) quest path choices of other students, or (2) non-linear quest-based curriculum creation by teachers. The method also includes associating the group of quest files and the at least one predetermined learning objective with at least one standard and using achievement tracking tools configured to indicate a status associated with each student. The achievement tracking tools are configured to indicate (1) each quest activity that each student has commenced, (2) a progress associated with each quest activity, and (3) each quest activity that each student has successfully completed. The method also includes using evaluation tools to evaluate work of each student.

A non-transitory computer readable medium having instructions thereon that when executed provides a method of learning in a cloud-based learning environment is disclosed herein. Students are presented with a group of quest files in which each quest file corresponding to a non-linear quest-based curriculum. The method includes presenting a student with a group of quest files and allowing the student to pursue a non-linear quest path to reach at least one predetermined learning objective. The group of quest files and the at least one predetermined learning objective are associated with at least one standard. The method also includes prompting the student to provide a least one of a plurality of student-mediated factors for each quest file of the group of quest files, and wherein the plurality of student-mediated factors comprises any factor that permits a student to influence (1) quest path choices of other students, or (2) non-linear quest-based curriculum creation by teachers.

A method of searching for a quest file in a cloud-based learning environment is included herein. The method includes receiving a search term comprising at least one of a tag, an author, a subject matter, an average time to completion, and an average rating, parsing a database of quest files having a creative commons license, wherein the parsing is based upon the received search term to arrive at a list of responsive quest files, and further wherein a quest file comprises a computer-accessible file comprising instructions for a quest activity that is presented to a student when the student has met all prerequisites associated with the quest file. The method also includes transmitting at least one responsive quest file.

### BRIEF DESCRIPTION OF THE DRAWINGS

FIGS. 1A and 1B show graphical representations of non-linear quest-based curricula. FIG. 1C shows a graphical representation of another embodiment of a non-linear quest-based curriculum.

FIG. 2 is a block diagram showing a non-linear quest-based curriculum.

FIG. 3 is a block diagram representing an environment that supports a non-linear quest-based curriculum.

FIGS. 4A-4E are screen shots of different portions of one environment for non-linear quest-based curricula. FIG. 4A illustrates the selection of a group or subject matter, according to one embodiment. FIG. 4B illustrates the selection of a quest, according to another embodiment. FIG. 4C illustrates one approach to awards and achievements within a non-linear quest-based curriculum. FIG. 4D illustrates the use of a progress tracking mechanism, in this case a player scorecard, in a non-linear quest-based curriculum. FIG. 4E illustrates how the environment may be optimized to search for quests, according to yet another embodiment.

FIG. 5 is a block diagram representing one method of teaching in a non-linear quest-based curriculum.

Like reference numbers and designations in the various drawings indicate like elements.

### DETAILED DESCRIPTION

In the following detailed description, reference is made to the accompanying drawings that form a part hereof, and in which is shown by way of illustration specific embodiments in which the current application may be practiced. These embodiments are described in sufficient detail to enable those skilled in the art to practice the application, and it is to be understood that other embodiments may be utilized and that various changes may be made without departing from the spirit and scope of the current application. The following detailed description is, therefore, not to be taken in a limiting sense.

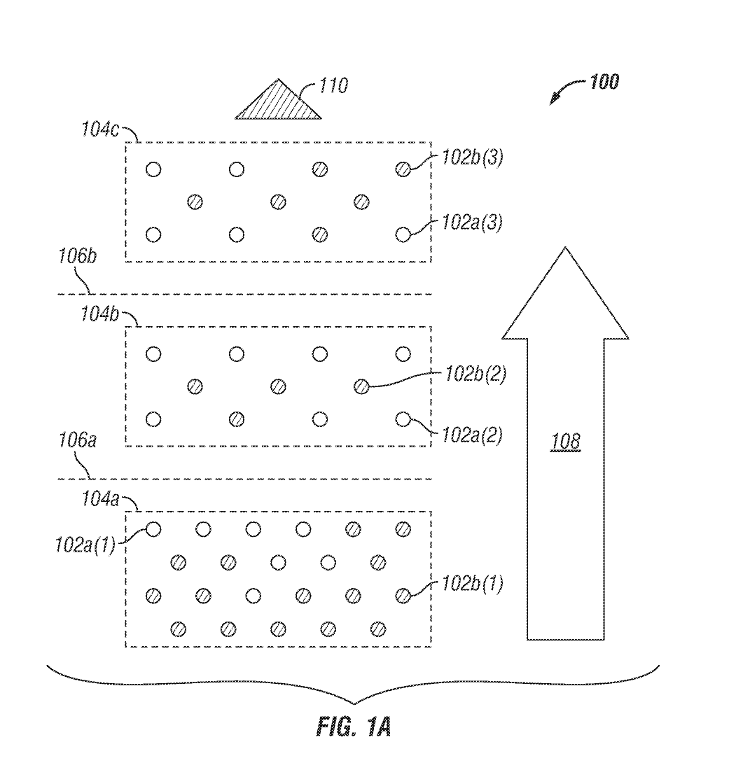

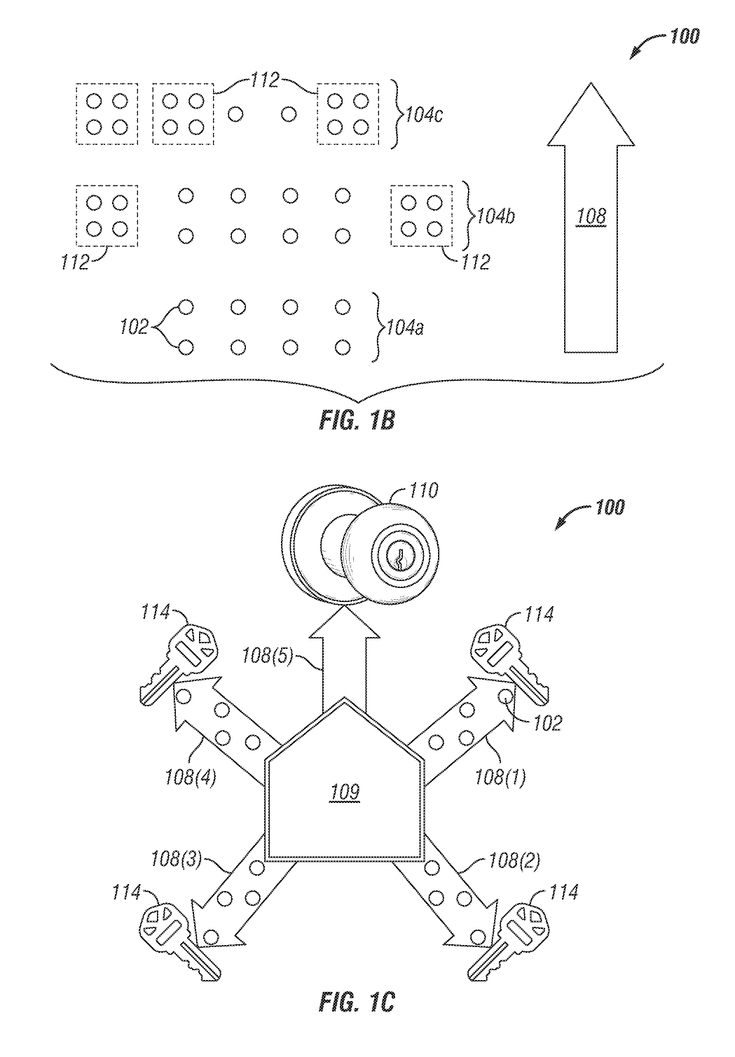

FIG. 1A illustrates a non-linear quest-based curriculum 100. In the illustrated embodiment, the non-linear quest-based curriculum 100 includes multiple modules 104a, 104b, and 104c and a final objective or winning condition 110. Each module 104a-c includes a plurality of individual quests, such as quests 102a(1)-(3) and 102b(1)-(3). As used herein, a quest comprises a computer-accessible file comprising instructions for an educational and/or quest activity that is part of a journey toward a larger goal, and that is delivered to a student when he or she is ready and able to engage in it, e.g., when the student has met all prerequisites associated with the quest, among other things. A quest file may comprise one or more quest activities. For instance, in one embodiment, a quest might ask a student to write a product review on a website. In this embodiment, the task of writing a product review might assist a teacher in teaching technical writing skills, among other things, and might be useful in an English or technical or persuasive writing class. In another embodiment, a quest might require a student to review and add detail to a Wikipedia entry. This task may be used by a teacher in a science class, in order to assist students to learn a particular topic.

Returning to FIG. 1A, quest 102a(1) has not been completed by the student, as indicated by a hollow circle, whereas quest 102b(1) has been completed by the student, as indicated by a filled circle. Each module 104a-c is separated from the other modules by conditions, such as conditions 106a and 106b, which may be thought of as thresholds to be met to advance from one module, e.g., 104a, to another, e.g., 104b. As illustrated by arrow 108, the non-linear quest-based curriculum 100 may be designed such that module 104a is to be undertaken first, then module 104b, and then module 104c.

As illustrated in FIG. 1A, a student or participant in non-linear quest-based curriculum 100 must progress from the initial stages of the curriculum up to the final objective 110 by reviewing and completing a series of quests, e.g., quest 102b(1). A student in a non-linear quest-based curriculum 100 may be allowed to pursue a non-linear quest path to arrive at the final objective 110, also referred to herein as a learning objective. It is to be understood that as used herein, “learning objective” or “final objective” may comprise the completion of a number of quests, each quest comprising at least one “quest objective,” and therefore, the “learning objective” or “final objective” of a curriculum may comprise a plurality of “quest objectives.” Thus the “learning objective” and “final objective” terminology is not intended to be understood in a restrictive sense. In a non-linear quest-based curriculum 100, the student has the option of completing quests which are of interest to the student, e.g., quest 102b(1), while opting to skip quests that are not of interest, e.g., quest 102a(1). For instance, in an initial learning module 104a (also referred to as a “module”), the student may select a plurality of quests, e.g., quest 102b(1), and upon completion of a predetermined number of quests and related quest activities, represented by condition or requisite 106a, the student may advance to the next module 104b.

For example, in one embodiment, non-linear quest-based curriculum 100 may be a United States history curriculum, module 104a may comprise quests covering the years 1500-1776, module 104b may comprise quests covering the years 1777-1860, and module 104c may comprise quests covering the years 1860-1950. In this example, module 104a could include quests, such as quests 102a(1) and 102b(1), requiring the performance of a predetermined learning activity, the completion of which could trigger the ability to continue to explore and undertake new quests. In this embodiment, the quests, e.g., 102a(1) and 102b(1) may be associated with a predetermined value, or experience points, the accumulation of which signals the student's ability to advance to new quests and/or new learning modules, e.g., 104b. For instance, the curriculum designer could determine that to move from module 104a to module 104b, the student must accumulate 500 experience points, as represented by condition or requisite 106a. The student may then be free to selectively undertake quests, e.g. quest 102b(1), to accumulate experience points and meet the predetermined condition 106a.

As used herein a teacher may be a typical classroom instructor, a curriculum designer, a tutor, and a parent, among other things. As the student completes quests, his or her progress in the non-linear quest-based curriculum 100 may be tracked by a teacher. For instance, if the teacher finds that a particular quest was not completed in a satisfactory fashion, the teacher may require the student to repeat the quest (e.g., a competency-based model), or may only award a limited number of experience points (e.g., pursue a curriculum model that may reflect more traditional learning models), among other things. The student may progress through modules 104a-c, by meeting the predetermined requirements or conditions, as represented by 106a and 106b, to finally achieve the predetermined final objective 110. In one embodiment, final objective 110 might be a mastery of certain aspects of U.S. history.

FIG. 1B illustrates another embodiment of a non-linear quest-based curriculum 100. FIG. 1B comprises quests 102, divided into three modules, 104a, 104b, and 140c, to be completed sequentially as illustrated by arrow 108. Additionally, FIG. 1B comprises specialty or emphasis groups 112 comprising additional quests.

In one embodiment, a student may encounter a subject or point of emphasis while completing a quest 102 or a module, e.g., 104a, that he or she finds to be of particular interest, and may create or assist in the creation of additional quests in order to provide additional emphasis or specialty for the given area. For instance, in one embodiment, if a student enjoys a quest about a certain colony in a U.S. history module, the student may then request additional quests concerning the colony.

In another embodiment, a teacher may note that one or more of the students in his class struggled with a given quest 102 and/or module, e.g., 104a, and may then create a supplementary quest and/or module in order to provide additional exposure to that area as deemed necessary by the teacher. For instance, if a teacher finds that a student in her class struggled with a quest about a certain topic, the teacher could then design any number of additional quests intended to provide additional exposure and instruction in that area. In one embodiment, this sub-group (e.g., 112) of quests can be made invisible to the rest of the class. For instance, in one embodiment, a quest or group of quests (e.g., 112) can be given a predetermined prerequisite, such as receiving a predetermined badge, and thereby make the quest or quest group otherwise invisible to the remaining students. Thus, for example, students may be encouraged to explore new areas, receive achievements, and otherwise achieve competency within the curriculum. In yet another embodiment, the completion of the sub-group of quests (e.g., 112) can be made a requisite for advancing to other quests.

FIG. 1C illustrates another approach to non-linear quest-based curricula. FIG. 1C shows a non-linear quest-based curriculum 100 comprising an initial position 109, a final objective 110, and four arrows 108(1)-108(4) representing quest paths and comprising quests 102, each arrow 108(1)-108(4) leading to a key 114, necessary to “open” the final objective 110, which is found at the extremity of arrow 108(5).

In one embodiment, a student can start at initial position 109 of a non-linear quest-based curriculum 100. For instance, initial position 109 may represent the position that a new student may find herself in at the beginning of an academic year in a new class. The student may be presented with four possible learning paths, represented by arrows 108(1)-108(4) that may be followed in order to eventually reach the final objective 110. The student may be permitted to select quests 102 in any, some, and/or all paths, e.g., arrows 108(1)-108(4), to probe interest.

For instance, in one embodiment the non-linear quest-based curriculum 100 may be for an algebra class. The student may begin at initial position 109 and may select from a plurality of quests 102 and learning paths, e.g., arrows 108(1)-108(4). For instance, in one embodiment, the learning path represented by arrow 108(1) may consist of quests 102, or learning exercises, where the student is asked to explore basic algebra principles through a series of physical experiments. In another learning path represented by arrow 108(2), the student may be asked to explore basic algebra principles through a series of practice problems performed on a sheet of paper.

In one embodiment, each path, e.g., arrows 108(1)-108(4), presents quests 102 covering the same subjects, but presented in differing quest formats. For instance, in this embodiment, learning path represented by arrow 108(1) may comprise quests 102 covering a variety of algebra-related topics, e.g., binomials, polynomials, fractions, etc., and the topics may be all covered in each of the learning paths, represented by arrows 108(1)-108(4), but in a different format, e.g., traditional practice problems in one path 108(1), flash cards in another path 108(2), and less-traditional physical experimentation-based methods in another path 108(3), among other things. In another embodiment, each path may present quests 102 covering different subjects, but in similar quest formats. For instance, in this embodiment, the teacher may decide that each quest path, e.g., arrow 108(1), may include different and distinct subjects such as, different sub-periods of art (e.g., Italian Renaissance, Baroque, Rococo, Romanticism, etc.) and nevertheless be able to reach the final objective 110. Thus, the student may be able to probe different sub-parts or topics of a given subject matter, select an area of particular interest, and focus his or her interest thereon. Alternatively, each path, e.g., arrow 108(1) may present quests 102 covering a combination of different topics and/or different quest formats. The student may be permitted to complete one or more learning paths, e.g., arrow 108(1), in order to achieve a “key” 114 to unlock a goal or final objective 110. As may be apparent to one skilled in the art, the non-linear quest-based curriculum 100 displayed in FIG. 1C could be implemented in the emphasis groups 112 discussed in relation to FIG. 1B. Additionally, many of the curriculum elements explained in FIGS. 1A-1C can be used interchangeably in different non-linear quest-based curricula.

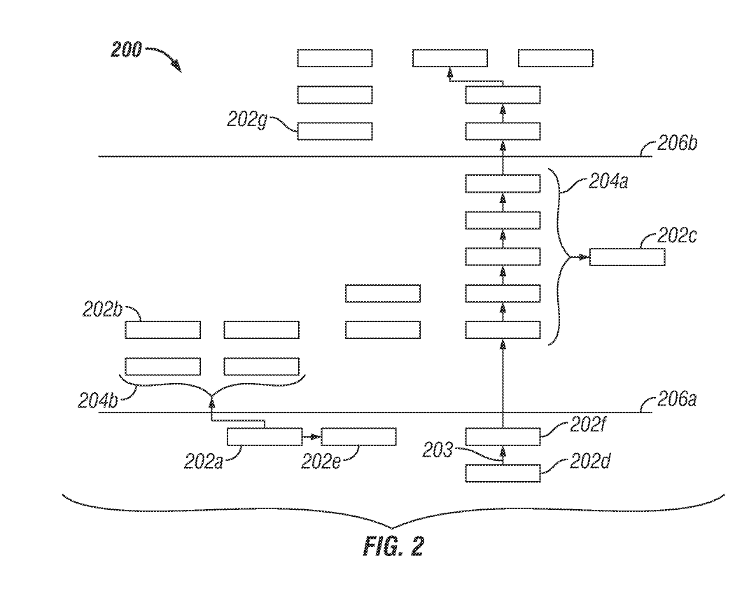

FIG. 2 is a block diagram of a non-linear quest-based curriculum 200. The non-linear quest-based curriculum 200 may include a number of quests, including, but not limited to, 202a-202g. The quests 202a-202g of non-linear quest-based curriculum 200 may be divided into a group of modules, as illustrated by dividing lines 206a and 206b representing the conditions required to move from one module to another (see, e.g., the discussion of 106a and 106b in FIG. 1A). In this embodiment, the quests may be interconnected as illustrated by arrows, e.g., 203, and grouped together by brackets, e.g., 204a and 204b.

In one embodiment, a student may be presented with a handful of quests 202a-202g from which to select. For instance, in one embodiment, a student may be presented with two initial quests 202a and 202d at the start of a course taught using a non-linear quest-based curriculum 200. The student may decide to complete quest 202a, following which, he or she may decide to continue to quest group or module 204b, which comprises quest 202b. However, prior to being able to begin module 204b, the student may need to complete additional quests in order to surpass the predetermined point threshold or condition 206a. In some embodiments, completion of quest 202a may give the student access to quest 202e. The student may complete quest 202d, which may give the student access to quest 202f.

In one embodiment, once the student has acquired sufficient points to meet the condition 206a, the student may be presented with additional quests, e.g., 202b and 202c, and/or modules, e.g., 204a and 204b. In one embodiment, students may be required to complete a quest, e.g., 202d, prior to undertaking another quest, e.g., 202f, as represented by arrow 203. For instance, in another embodiment, provided that the student has completed quest 202a, he or she may then begin the quests in module 204b. As illustrated, the quests, e.g., 202b, within module 204b may not be connected, meaning that in some embodiments they can be completed in any order. Also, the quests within module 204b might not be connected to any further quests. However, in one embodiment, the quests in module 204a are linked to each other, and in fact, as illustrated in one embodiment, module 204a must be completed prior to completion of quest 202c. Of course, the student may complete quests between conditions 206a and 206b in order to accumulate points and advance across condition 206b.

In one embodiment, as the student gains enough points, or other relevant predetermined criteria, to cross condition 206b, the student may be given access to new quests, e.g., 202g, and/or modules (not shown). The curriculum may be considered “completed” once the student reaches a predetermined final objective, see, e.g., 110 in FIGS. 1A and 1C. For instance, if the curriculum creator determines that completion of the course is dependent on the accumulation of 500 points, once the student completes enough quests to gain 500 points, then the student has completed the curriculum. Of course, the curriculum creator could add and/or substitute any number of possible conditions upon which completion is dependent such as, for example, completion of a project such as a paper, report, thesis, and/or dissertation.

In one embodiment, non-linear quest-based curriculum 200 may be employed to teach a course on computer programming. In this embodiment, quest 202d may comprise a basic introduction and tool orientation project to familiarize the students with the subject matter and the tools that they will use throughout the course. Completion of quest 202d might “unlock” quest 202f and/or 202a. In one embodiment, quest 202f might comprise the ubiquitous “hello world” assignment, the completion of which might be sufficient to meet condition 206a and enter a new module 204a for the course. In some embodiments, quest 202a may comprise a non-required exploratory project designed to present the students with an opportunity to encounter materials that might not be examined in a traditional course format, such as, for instance, content display manipulation and/or user interface. Completion of quest 202a might then allow the student to explore module 204b comprising, among others, quest 202b, which, if 204b is a user interface module, might ask the student to complete a dynamic user interface using a MySQL backend. In this way, non-linear quest-based curriculum, e.g., 100, allows and encourages the student to complete quests comprising both required and supplemental material.

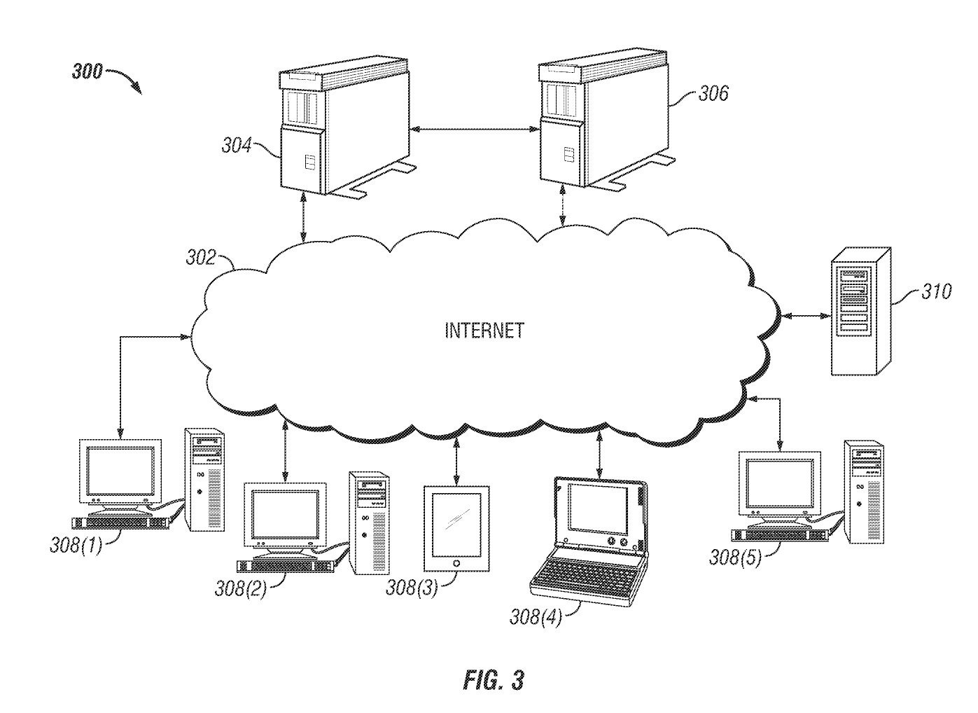

FIG. 3 is a block diagram illustrating network 300 and the relationship of different clients 308(1)-308(5) to an interface/content server 306 configured to transmit and receive content from clients 308(1)-308(5) through a WAN, such as Internet 302. In FIG. 3, interface/content server 306 is connected to clients 308(1)-308(5) through web server 304; however, as would be understood by one of ordinary skill in the art, interface/content server 306 may be configured to connect directly to Internet 302. Additionally, a school server 310, or server associated with some other organization or institution, may be connected to Internet 302.

Suitable client devices can comprise desktop computers (e.g., 308(1), 308(2), and 308(5)), handheld and mobile devices such as tablets (e.g., 308(3)), and laptops and netbooks (e.g., 308(4)), among other things. Clients 308(1)-308(5) may be configured to connect to Internet 302 via any suitable method including, among other things, cable, xDSL, and cellular data connections. The connection to Internet 302 may pass through a wired Ethernet connection, a WiFi connection, or any other suitable connection type. Clients 308(1)-308(5) may be configured to receive and display data corresponding to non-linear quest-based curricula, e.g., 200. In some embodiments, the client, e.g., 308(1), might comprise an Internet browser configured to display remotely stored content. In these embodiments, a non-linear quest-based curriculum may reside remotely on a plurality of web servers 304, interface/content servers 306, and/or school servers 310, and may be accessible via the Internet browser of the client, e.g., 308(1).

In one embodiment of network 300 of FIG. 3, Internet 302 illustrates a wide-area network (WAN) connecting devices, computers, and servers across the globe. However, it is to be understood that non-linear quest-based learning may take place, for instance, wholly within a LAN or intranet environment.

In one embodiment, school server 310 represents an entry point into the non-linear quest-based environment for an educational institution. For instance, school server 310 may be a computer or server comprising a database of quests created and/or hosted by an educational institution. In one embodiment, school server 310 may house records associated with students who attend the school, and thereby track each student's performance as he or she completes quests in a non-linear quest-based learning environment. Additionally, school server 310 may house tools and other resources for its teachers, i.e., curriculum creators, to enable their use of non-linear quest-based learning environments.

Web server 304 may comprise any suitable type of network server, including, but not limited to, an HTTP server. In some embodiments, it may not necessary to have a web server 304, and clients 308(1)-308(5) and interface/content server 306 may be configured to communicate directly with one another. Interface/content server 306 may comprise any suitable form of server configured to house code and data associated with an embodiment of a non-linear quest-based learning environment. For instance, if the non-linear quest-based learning environment is web-based, then the interface/content server 306 may comprise the code configured to display the web page associated with the non-linear quest-based learning environment. Interface/content server 306 may comprise a database component configured to store information associated with quests, modules, and curriculum of a non-linear quest-based learning environment. Interface/content server 306 may also comprise a database component configured to store user information associated with users and/or curricula designers. In practice, interface/content server 306 may comprise a plurality of servers.

In operation, network 300 housing a non-linear quest-based learning environment may be configured to permit a curriculum designer or teacher to create and/or distribute a non-linear quest-based curriculum, e.g., 100, to a group of students. In one embodiment, the non-linear quest-based curriculum 100 may comprise any number of pre-developed or new quests, e.g., 202a-202g, and/or modules, e.g., 204a and 204b. For instance, the curriculum designer may design a group of quests for a course, but may also include other distributable quests, for instance, quests created under a Creative Commons license arrangement. Students may then access the non-linear quest-based curriculum 100 via a client 308(1)-308(5). The teacher may follow the progress of his or her students via tools made available on the interface/client server 306 and/or through the school server 310. The non-linear quest-best learning environment may be configured with achievement tracking tools designed to permit tracking of student progress and achievement. For instance, in one embodiment, the teachers' achievement tracking tools may include a user interface configured to display student progress as a series of bar graphs. In another embodiment, the teacher may be able to refer to the achievement tracking tools to identify quests commenced, in progress, and finished, including the ability to review work and participation, among other things. In yet another embodiment, the non-linear quest-based learning environment may include evaluation tools configured to permit access to students' work in order to evaluate and provide a score, award experience points, and grant badges, achievements, and awards, among other things.

In some embodiments, network 300 may facilitate a non-linear quest-based curriculum, e.g., 100, and learning environment located remotely, or “in the cloud.” As used herein, an environment configured to facilitate learning and teaching via a non-linear quest-based curriculum 100 that is accessed via a network, such as network 300, is referred to a cloud-based learning environment. As may be understood, different components and parts of the non-linear quest-based curriculum 100 may be stored on one or more than one interface/content servers 306 and/or school servers 310. The examples of a network 300 and cloud-based learning environments discussed herein are not to be understood in a limiting sense, but rather, are presented to illustrate one of many possible embodiments contemplated by the current application.

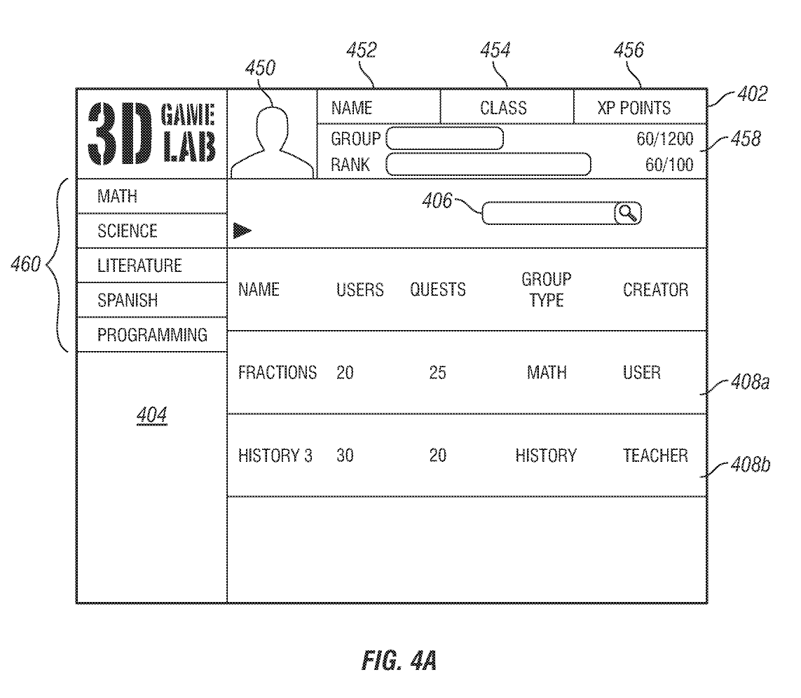

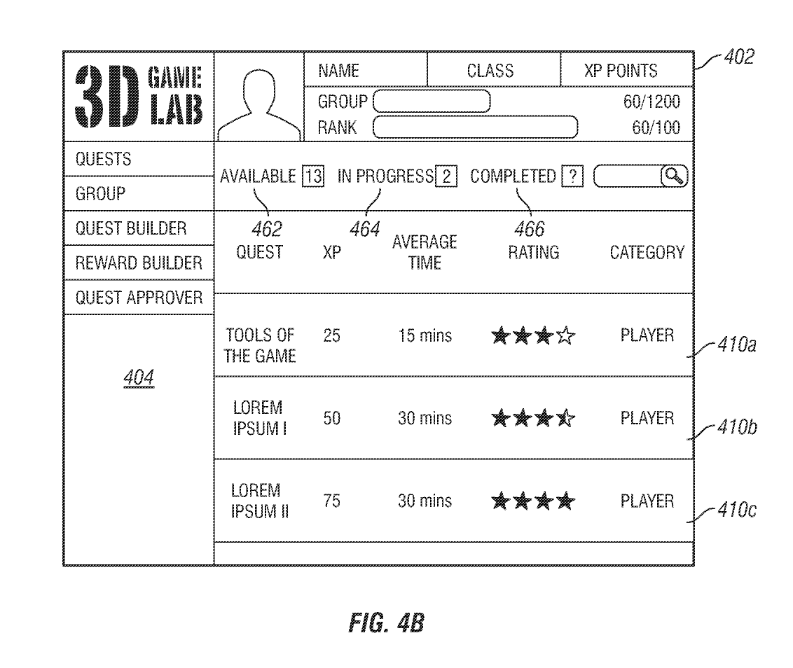

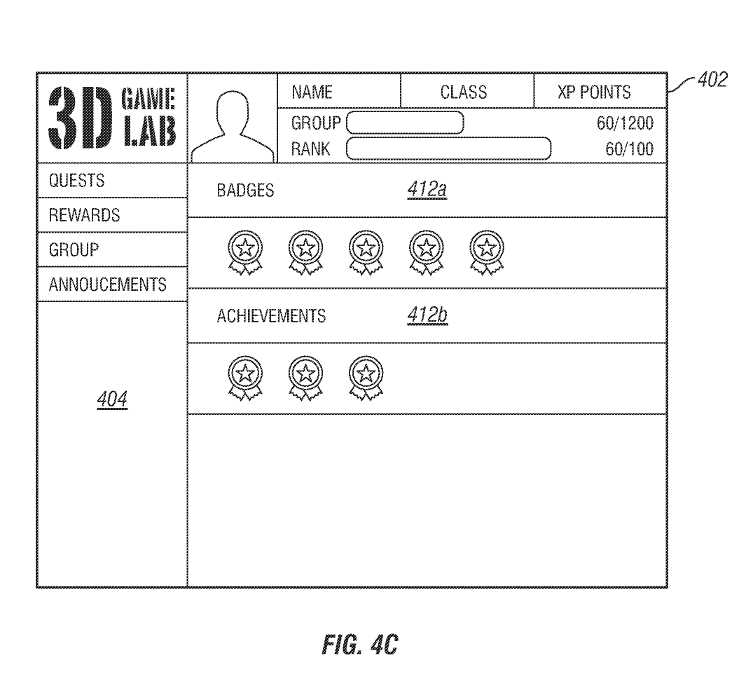

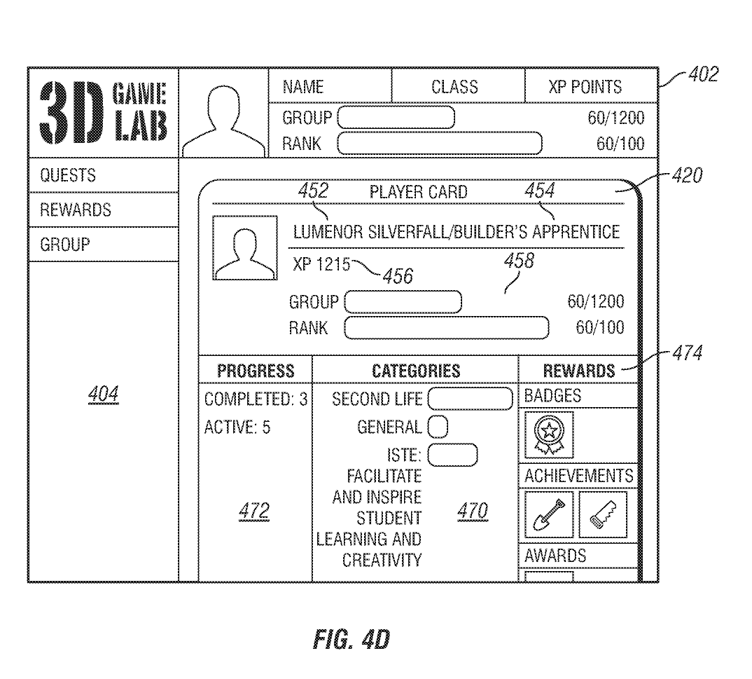

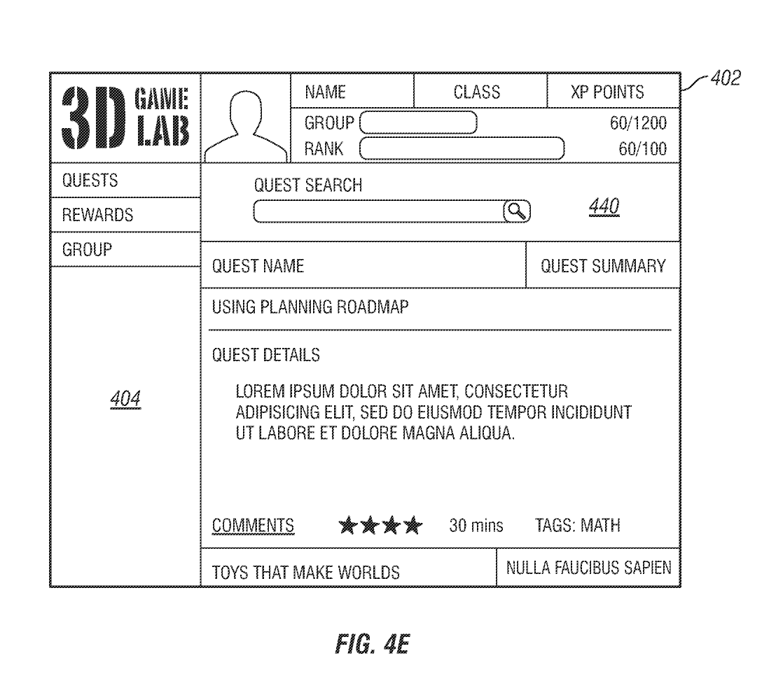

FIGS. 4A-4E illustrate embodiments of non-linear quest-based learning environments. These examples are provided to illustrate different possible implementations of non-linear quest-based learning environments and interfaces and are not to be taken in a limiting sense. FIG. 4A is a screen shot of a user interface in one embodiment of a non-linear quest-based learning environment. The non-linear quest-based learning environment user interface may include a top information bar 402 comprising a user avatar 450, a name 452, a class 454, an experience point (XP) total 456, and progression bars 458 indicating progress in a group and in a rank. As used herein, an avatar is a graphical representation of a learner or a teacher. As used herein, a name is a unique user identification assigned to a student and a teacher. As used herein a class is a group or category of students on the basis of, for instance, grade level, learning interests, traits, and or qualities, among other things. The non-linear quest-based learning environment may also include a sidebar 404 comprising a list of groups 460 (i.e., courses) to which a user or student may have “subscribed” or within which the user may be active. As illustrated in FIG. 4A, Sidebar 404 may include a list of groups 460 comprising, for instance, Math, Science, Literature, Spanish, and Programming. Of course, any imaginable subject or topic is contemplated herein. Also illustrated in FIG. 4A, one embodiment of the user interface of the current application may include a search bar 406 and a results list comprising group search result entries 408a and 408b.

In use, a student can log into his or her account associated with non-linear quest-based learning through a user interface, and may be presented with a list of assigned groups corresponding to different subjects or classes. The student may search for additional group search result entries, e.g., 408a and 408b, may read the explanation corresponding to each, and may choose to join a group from the search result entries, e.g., 408a and 408b. The student may be able to view his experience point (XP) total 456 at this page, and may also be able to track his progress within a group or a rank via progression bars 458. The student may also be able to select a group from the group list 460 in order to enter the group and perform quests therein, and as explained in relation to FIG. 4B.

FIG. 4B is a screen shot illustrating quest selection according to one embodiment of a user interface for a non-linear quest-based learning environment. In one embodiment, a student can select a quest 410a, 410b, or 410c presented at this screen and may complete the quest, e.g., 410a, and/or may move on to a different quest, e.g., 410b. As explained above, initially the student may only have a limited number of quests, e.g., 410a and 410b, available to choose from, but as the student completes quests, new quests, e.g., 410c, and modules (see, e.g., 104a in FIG. 1A) may be presented to the student (or “unlocked” in gaming terminology). As illustrated in FIG. 4B, the screen may display a number of quests available 462, the number of quests in progress 464, and the number of completed quests 466. In one embodiment, the quests may be sorted alphabetically, by number of XP points, by average time of completion, by rating, and by category, among other things. The user interface may include a button (which may be a “hotspot” in JavaScript terms, or any other term as used in different languages and/or environments) to access the number of quests available 462, which may be configured to provide access to a list of all of the possible quests that may be undertaken by the student. In some embodiments, the button to access the number of quests available 462 may comprise an indicator configured to display a number corresponding to the number of quests available. The user interface may include a button to access the number of quests in progress 464, i.e., quests that may have been commenced, but not completed. As with the available quest button 462, the quests in progress button 464 may provide the student with a list of quests that are in progress, and may include an indicator configured to display a number corresponding to the number of quests in progress. The user interface may also include a button to access the number of quests completed 466. As with the available quest button 462, and the quests in progress button 464, the completed quests button 466 may provide the student with a list of quests that are completed, and may include an indicator configured to display a number corresponding to the number of quests completed. In some embodiments, the user interface may be programmed in any suitable programming language to permit the student to access the non-linear quest-based learning environment. For instance, the interface may be programmed using a combination of HTML, HTML5, JavaScript, Java, Ruby on Wheels, PHP, among other things.

In one embodiment, as a student selects and performs a quest, e.g., 410a, the student may be prompted to comment on the quest, e.g., 410a, including, providing a rating, an amount of time that it took to complete, and general comments. The provided information may then be aggregated in order to give the curriculum designer and/or teacher feedback as to which quests and modules are popular and which might need attention. Also, the student-provided information may provide other students information that may guide their decisions as to which learning path to pursue, and therefore providing tools for student to moderate the learning environment for peers within the group. As used herein, factors such as the rating, time of completion, and general comments are referred to as “student-mediated factors.” Student mediated factors might include any other factors that provide students with the opportunity to influence the quest path choices of other students or the non-linear quest-based curriculum creation by teachers.

In some embodiments, the teacher or curriculum designer may wish to provide awards or other incentives to students. FIG. 4C is a screen shot of one embodiment of a user interface for an award system in a non-linear quest-based learning environment. The non-linear quest-based learning environment may include awards and/or other motivation to encourage students to advance within the curriculum. As illustrated in FIG. 4C, in one embodiment, the non-linear quest-based learning environment may include a section for badges 412a and for achievements 412b, among other things. As used herein, a badge is any distinguishing mark, symbol, sign, token, or emblem configured to show a collection of activity, e.g., rank, membership, or accomplishment of a feat or task. As used herein, an achievement is any distinguishing mark, symbol, sign, token, or emblem configured to show a system activity and/or behaviors. As used herein, an award is any distinguishing mark, symbol, sign, token, or emblem configured to show extensions of the completion process. Badges, achievements, and awards may be awarded according to pre-select criteria or may be auto-rewarded, among other things. The non-linear quest-based learning environment may display icons representing badges, achievements, and awards, among other things. In one embodiment, the badges 412a, achievements 412b, and awards may appear within the user interface as digital and/or analog representations of actual badges or medals. In another embodiment, the badges 412a, achievements 412b, and awards may appear as other icons or may take a tangible form which may be reflected within the non-linear quest-based learning environment. For example, if the curriculum designer or teacher offers a pizza party award for accomplishing a task and/or a quest, the award may be reflected within the non-linear quest-based learning environment as an icon resembling a pizza box. Of course, as may be understood by one of ordinary skill in the art, the awards, badges, and achievements may take any number of possible forms and representations and are only limited by the creativity of the curriculum designer and/or teacher.

In operation, the curriculum designer may create a series of badges 412a, achievements 412b, and awards to be given to students based upon meeting a predetermined requirement. Additionally, the curriculum designer may create awards, badges 412a, and achievements 412b on an on-the-fly basis while students are advancing within the curriculum. For instance, in one embodiment, the curriculum designer may create a series of badges based on the completion of certain quests, other badges and achievements based on the quality of a student's work, and may create additional badges based on any other factors which might, in his or her determination, make a student meritorious. In one embodiment, a curriculum designer might make badges 412a, achievements 412b, and other awards corresponding to the completion of quests, to participation in class, and to the quality of work, among other things. For example, the curriculum designer might create badges 412a corresponding to milestones within the curriculum, such as completion of modules and/or quest progressions or series. As is to be understood, the ability to construct an award and recognition system around a non-linear quest-based learning environment gives the curriculum designer the ability to construct novel and unique award systems specific to a group of students and/or a subject matter, among other things.

FIG. 4D illustrates one embodiment of a player card system according to one embodiment of a user interface for a non-linear quest-based learning environment. A player card system, as used in this application, may be any system that allows a student and/or a teacher to view attributes, such as the student's progress, associated with a student, including, but not limited to, progress within a group and/or quest, experience points, awards, badges 412a, and achievements 412b, among other things. For instance, in one embodiment, a student's player card may include the student's user name 452, the student's association with a given group or interest, i.e., class, 454, the student's experience points 456 and/or status within the learning environment, the student's rank and the student's progress 458, the student's categories of interest 470, the student's rewards 474, and/or any other indication of the student's participation in the non-linear quest-based learning environment. In one embodiment, the student's player card can include an archive of the student's comments on different quests.

In use, one embodiment of the player card system operates much in the same way as do current versions of computer and video games player cards. For instance, online multiplayer and MMORPGs allow players to view each other's player cards to, among other things, allow players to find new “friends” with whom to play and associate. In a learning environment, a player card may offer much of the same functionality and utility. For instance, students may be able to consult their co-students' player cards in order to find students with similar interests and with whom they might be able to complete quests, cooperate in learning situations, and otherwise interact. Rather than becoming a hindrance to the learning environment, the player card can permit student interaction to enhance learning and cooperation to the benefit of students. In some embodiments, player cards may offer a useful glimpse of a student to a teacher, among other things.

FIG. 4E is a screen shot illustrating a quest search embodiment of one possible non-linear quest-based learning environment user interface. The user interface may comprise a quest search pane 440, and a component configured to display a list of search results. The quest search embodiment may be configured to display a summary of quests but allow a student to click on a quest to receive a detailed description. The quest search embodiment may be configured to permit a student to search based on a number of criteria such as, for example, rating, average time of completion, tags, subject matter, and student comments, among other things.

For example, according to one embodiment of a user interface for a non-linear quest-based learning environment, a student may be allowed access a quest search component and enter a search term, and specify that he or she would like the results to be returned and/or sorted based on rating, average time of completion, subject matter, and tags, among other things. For instance, if a student enjoyed a quest on a certain subject, for instance, the Napoleonic Wars, the student can search the entire universe of created quests for other quests related to the same or similar subjects. In one embodiment, the student can then view potentially responsive quests in the search pane 440, and be prompted to send a communication to the student's curriculum designer and/or teacher to suggest that the newly found quest be added to the student's curriculum. Or, in another embodiment, if a student only has a set time to work and the student would like to find quests that could be completed in that time period, the student could search for quests based on average time of completion, to find a quest that he or she could complete within his or her window of availability.

In some embodiments, when a curriculum designer or teacher designs quests and/or curricula, he or she may opt to adopt a Creative Commons License agreement for his or her quests and/or curricula. Once the Creative Commons License is applied to the designed quest and/or curriculum, they may be added to a shared database configured to be accessible to all users and thereby facilitate the creation of curricula, the sharing of popular quests and/or curricula, and, more generally, the exchange of learning tools, among other things. Generally speaking, Creative Commons licensing allows the distribution and use of materials that would be otherwise restricted under traditional copyright law's default use provisions. Of course, any licensing agreement that would allow relatively simple distribution of content would be acceptable to the operation of the present application. Thus, a non-linear quest-based learning environment can allow curriculum designers to create a large number of learning materials, i.e., quests and curricula, which may be cloned and used by other curriculum designers and students.

Additionally, a curriculum designer may be able to apply other features to a given quest and/or curriculum such as, among other things, prerequisites, standards, tags and/or categories. Thus, in one embodiment, a curriculum designer may create a plurality of quests as part of a new curriculum. The curriculum designer may adopt a Creative Commons licensing framework for the quests and curriculum in order to allow other curriculum designers, teachers, and students, access, evaluate, use, and even clone. When creating a curriculum and/or quest, the curriculum designer may assign a prerequisite, such as completion of a previous quest or curriculum, or receiving an achievement, among other things. The curriculum designer may also indicate that a given quest and/or curriculum meets certain learning standards, such as the standards for a given state. The curriculum designer may also apply tags or category markers in order to allow other curriculum designers, teachers, and students to easily find a given quest or curriculum.

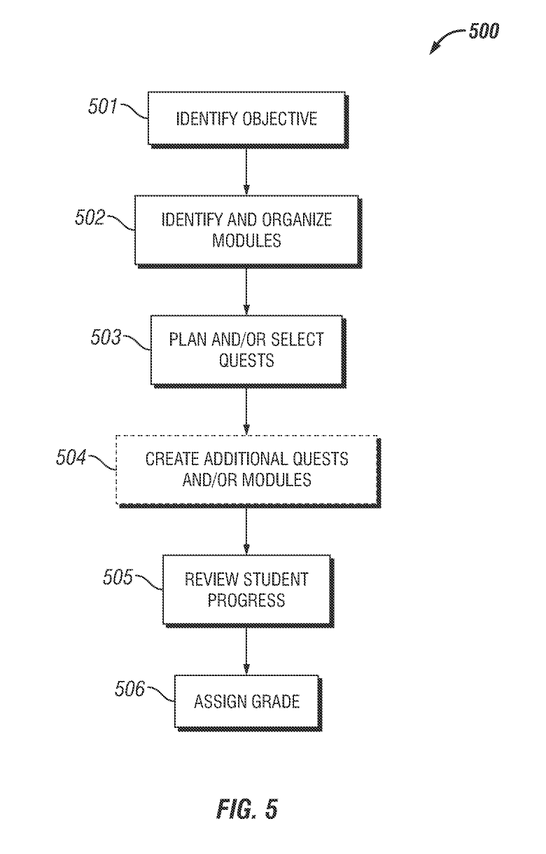

FIG. 5 illustrates a method 500 of one possible embodiment for using a non-linear quest-based learning environment to teach a course. In a first method step 501, the teacher or curriculum designer (as used in relation to the explanation of method 500, teacher and curriculum designer are synonymous and may be used interchangeably) identifies a final objective, e.g., 110, that she would like her students to achieve to “complete” the course. In one embodiment, this might include identifying mastery of certain topics, completion of certain assignments, etc., which might be, in some cases, required by an educational board, such as a state department of education, for a given subject matter, and that are referred to herein as “standards” for a particular educational body.

In a next method step 502, the curriculum designer identifies and organizes modules in order to, in one embodiment, lead the student through the curriculum in order to achieve the required objective. For instance, in one embodiment, and if the course objective is to achieve mastery of certain predetermined events and dates in Post-Renaissance European History, the curriculum designer may elect to create a series of modules to make sure that the student has the necessary foundation to pass the class. The curriculum designer may also design a reward system including rewards, badges, and achievements, among other things. These rewards, badges, and achievements may be tied to larger achievements, to standards, to levels, and to final points required to meet the predetermined final objective of the curriculum (i.e., to “win” the course).

In a third method step 503, the curriculum designer creates a plurality of quests, or selects a plurality of quests from a database, corresponding to the modules identified in the preceding method step 502. For instance, for the modules corresponding to Post-Renaissance European History in the previous example, the curriculum designer might create a quest asking the student to create an electronic photo album corresponding to different sites in Europe and explaining the importance thereof as related to a module concerning, for instance, the French student strike of 1968.

In an optional fourth method step 504, the teacher may recognize a need or a student may request additional quests and/or modules covering a given topic or area, and may create, search for, and add quests and/or modules to the curriculum. In some embodiments, the teacher may elect to make the quests and/or modules visible to only a portion of students. For instance, if the teacher notes a weakness is a certain area, he may desire to create an additional module and new quests designed to improve the noted weakness. For instance, if students in a non-linear quest-based biology class appear to be lacking certain foundational understanding of, for instance, how mitochondria function, the teacher may elect to first search a database of quests to find supplemental materials, and/or design her own quests to make sure that the students have the necessary foundations to, not only reach the course's predetermined objectives, but succeed in subsequent courses.

In another method step 505, the teacher may review her students' progress in a given non-linear quest-based curriculum, e.g., 100. For instance, in one embodiment, the teacher may wish to consult charts, graphs, spreadsheets, etc. detailing quests and modules completed by her students. In some embodiments, this information will indicate whether a student or students are progressing satisfactorily. In one embodiment, the teacher may elect to use this information to provide her students with awards, badges 412a, and achievements 412b.

In yet another method step 506, the teacher may assign a grade to his students. For instance, the teacher may determine that a student that earns a threshold of experience points (XP) would earn an ‘A,’ a different threshold would earn a ‘B,’ and so on. In some embodiments, grades may be assigned on a pass-fail basis. For instance, in one embodiment, the final objective of a course might be determined to be earning 1,000 experience points (XP), and thus a student who works to gain 1,000 points within the first six weeks of the class might be awarded an ‘A’ or passing grade, and may be permitted to focus on other materials, or even advance to a subsequent course. As may be readily understood by those of ordinary skill in the art, the flexibility of the system proposed by the current application allows limitless possibilities to tailor courses to students, to allow students to succeed, and to provide a framework that is workable for both the advanced and less-advanced students of a course, among other things.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A method of teaching in a cloud-based learning environment, wherein students are presented with a group of quest files, each quest file corresponding to a non-linear quest-based curriculum, the method comprising:
creating a group of quests files to enable a student to pursue a non-linear quest path to reach at least one predetermined learning objective, wherein a quest file comprises a computer-accessible file comprising instructions for a quest activity that is presented to a student when the student has met all prerequisites associated with the quest file, and wherein at least one of (1) the group of quest files, and (2) the at least one predetermined learning objective, is created by a teacher of the student;
wherein each quest file in the group of quest files is configured to be associated with at least one of a plurality of student-mediated factors, and further wherein the at least one student-mediated factor comprises any factor that permits a student to influence (1) quest path choices of other students, or (2) non-linear quest-based curriculum creation by teachers;
associating the group of quest files and the at least one predetermined learning objective with at least one standard;
using achievement tracking tools configured to indicate a status associated with each student;
wherein the achievement tracking tools are configured to indicate (1) each quest activity that each student has commenced, (2) a progress associated with each quest activity, and (3) each quest activity that each student has successfully completed; and
using evaluation tools to evaluate work of each student.

2. The method of claim 1 wherein the at least one predetermined learning objective comprises amassing a predetermined number of total experience points, each quest file having a predetermined number of experience points that are awarded to a student upon successful completion of the corresponding quest activity, and allowing the student to select from the group of quest files to reach the predetermined number of total experience points.

3. The method of claim 1 further comprising:
creating at least one new quest file to supplement the previously created group of quest files; and
assigning the at least one new quest file to at least one student.

4. The method of claim 1 further comprising:
receiving a request from a student for at least one new quest file to supplement the previously created group of quest files; and
assigning the at least one new quest file to the student, the at least one new quest file comprising either: (1) a newly created quest file, or (2) a pre-existing quest file indexed in a database.

5. The method of claim 1 further comprising awarding at least one of (1) an award, (2) a badge, or (3) an achievement, based on completion of a quest activity associated with a quest file or a group of quest files.

6. The method of claim 1 further comprising cloning a pre-existing quest file for use in the non-linear quest-based curriculum.

7. The method of claim 1 wherein the at least one standard comprises a state educational standard.

8. The method of claim 1 wherein the plurality of student-mediated factors comprises at least two of: (1) a rating, (2) a time of completion, and (3) a comment.

9. A non-transitory computer readable medium having instructions thereon that when executed provides a method of learning in a cloud-based learning environment, wherein students are presented with a group of quest files, each quest file corresponding to a non-linear quest-based curriculum, the method comprising:
presenting a student with a group of quest files and allowing the student to pursue a non-linear quest path to reach at least one predetermined learning objective;
wherein the group of quest files and the at least one predetermined learning objective are associated with at least one standard; and
prompting the student to provide a least one of a plurality of student-mediated factors for each quest file of the group of quest files, and wherein the plurality of student-mediated factors comprises any factor that permits a student to influence (1) quest path choices of other students, or (2) non-linear quest-based curriculum creation by teachers.

10. The non-transitory computer readable medium of claim 9 wherein each quest file in the group of quests is assigned a predetermined number of experience points that are awarded upon completion of a quest activity corresponding to each quest file.

11. The non-transitory computer readable medium of claim 9 further comprising:
displaying a unique player card for each student; and
wherein the unique player card comprises information corresponding to each student's participation and progress in the cloud-based learning environment.

12. The non-transitory computer readable medium of claim 9 further comprising displaying at least one award, badge, or achievement corresponding to predetermined criteria.

13. The non-transitory computer readable medium of claim 9 wherein the plurality of student-mediated factors includes at least two of: (1) a rating, (2) a time required to complete a quest activity corresponding to each quest file, and (3) a comment.

14. The non-transitory computer readable medium of claim 9 wherein the at least one standard comprises a state educational standard.

15. The non-transitory computer readable medium of claim 9 wherein the at least one standard comprises a post-secondary education standard.

16. A method of searching for a quest file in a cloud-based learning environment, the method comprising:
receiving a search term comprising at least one of a tag, an author, a subject matter, an average time to completion, and an average rating;
parsing a database of quest files having a creative commons license, wherein the parsing is based upon the received search term to arrive at a list of responsive quest files, and further wherein a quest file comprises a computer-accessible file comprising instructions for a quest activity that is presented to a student when the student has met all prerequisites associated with the quest file; and
transmitting at least one responsive quest file.

17. The method of claim 16 further comprising:
displaying a plurality of quest files responsive to the received search term;
displaying a summary description for each quest file;
displaying a detailed description for a quest file; and
sorting the displayed plurality of quest files based on a rating, an average time of completion, or a tag.

18. The method of claim 17 further comprising:
displaying the summary description by default; and
displaying the detailed description upon request.

19. The method of claim 16 wherein each of the responsive quest files is associated with at least one standard comprising a state educational standard.

20. The method of claim 16 further comprising displaying a button for cloning one of the responsive quest files.
